(19) United States
(12) Patent Application Publication
(10) Pub. No.: US 2025/0384775 A1
(43) Pub. Date: Dec. 18, 2025

(54) Electronic system and method for assisting a civil aircraft operator in decision making with the elaboration of aeronautical indicator(s), related civil aircraft and computer program

(71) Applicant: THALES, Meudon (FR)

(72) Inventors: Tom FOUGERE, TOULOUSE CEDEX 1 (FR); Clara LOPEZ, TOULOUSE CEDEX 1 (FR)

(21) Appl. No.: 19/231,510

(22) Filed: Jun. 8, 2025

(30) Foreign Application Priority Data
Jun. 13, 2024 (FR) 2406255

(51) Int. Cl. G08G 5/23; G08G 5/21; G08G 5/26; G08G 5/76

(52) U.S. Cl. CPC G08G 5/23; G08G 5/21; G08G 5/26; G08G 5/76

(57) ABSTRACT

An electronic decision-making assistance system for an operator of a civil aircraft, including an electronic display device for displaying information, an electronic production device for producing aeronautical indicators, including an acquisition module for acquiring at least one aeronautical information message including a header and a useful part, the useful part including several data fields, including a free-format text field called free field, a calculation module for calculating a plurality of aeronautical indicators for each aeronautical information message by applying an artificial intelligence (AI) algorithm to the message, the AI algorithm receiving the free field as input and delivering the indicators as output, the indicators being distinct from the data contained in the message, and a display module for displaying a readout of the aeronautical indicators.

### REFERENCE TO RELATED APPLICATION

This application is a U.S. non-provisional application claiming the benefit of French Patent Application No. 24 06255 filed on Jun. 13, 2024, the contents of which are incorporated herein by reference in their entirety.

### TECHNICAL FIELD OF THE INVENTION

The present invention relates to a method for assisting a civil aircraft operator in decision making, and to a decision-making assistance method implemented by such a system.

The invention also relates to a civil aircraft including such a system for assisting a civil aircraft operator in decision making, and to a non-transitory computer-readable medium including a computer program including software instructions which, when executed by a computer, implement such a decision-making assistance system.

The invention relates to the field of air transport, and more specifically to information for pilots via aeronautical information messages, such as NOTAM (Notice to Airmen) messages, SNOWTAM messages or ASHTAM messages.

### BACKGROUND OF THE INVENTION

A NOTAM message is an official communication issued by a civil aviation regulatory authority to inform pilots of any significant or disruptive element related to flight operations. These notifications may relate to temporary changes, closures, or operational constraints in a given airspace.

A SNOWTAM message (a combination of SNOW and NOTAM) is a NOTAM message relating to snow conditions on airport runways.

An ASHTAM message (a combination of ASH and NOTAM) is a NOTAM message providing information on the state of activity of a volcano when a change in its activity is or is expected to be operationally significant.

For flight operations, NOTAM messages provide valuable information about work in progress on runways, unavailable navigation equipment, airport closures, flight restrictions, temporary obstacles such as cranes, faulty signal lights, military exercise areas, danger zones, and many other relevant facts. This information is essential to ensure flight safety and to enable pilots to plan their routes, avoiding areas facing risk or disruption.

NOTAM messages are regularly updated to reflect changes in temporary situations, work in progress, and operational changes. It is therefore important for pilots to consult NOTAM messages regularly to obtain the latest information and make appropriate decisions during their flight operations.

Unfortunately, thousands of NOTAM messages are sent out every day, and the number is increasing rapidly. One of the reasons for this rapid increase is a lower and lower threshold for sending a new NOTAM message, which sometimes leads to irrelevant NOTAM messages. As a result, each pilot has to search for and sort through an increasing number of NOTAM messages, wasting time and increasing the risk of overlooking important messages. In major airlines, a “NOTAM agent” is sometimes responsible for checking NOTAM messages before passing them on to pilots.

To remedy this, it is known to apply classification models in order to classify NOTAM messages into different possible classes, and in particular to indicate to the pilot for each NOTAM message whether it is important, i.e., critical, or on the contrary not to be taken into account. The papers “NOTAM Text Analysis and Classification Based on Attention Mechanism” by B. Mi et al (2022), “Knowledge extraction from aeronautical messages (NOTAMs) with self-supervised language models for aircraft pilots” by A. Arnold et al (2022), and “NOTAM Smartification” by M. Bravin (2020) describe such classification models, with the last of the above papers also proposing the removal of unnecessary words or phrases from NOTAM messages.

Also known, from document FR 3 061 342 B1, is a semantic analysis of the content of NOTAM messages using automatic language processing, followed by a comparison of the analyzed content with details from aeronautical databases.

Such processes can help the aircraft pilot, but this help is sometimes insufficient.

### SUMMARY OF THE INVENTION

The purpose of the invention is therefore to propose an electronic system and a method for assisting the decision-making of a civil aircraft operator, making it easier for a pilot to take account of such aeronautical information messages, in particular of the NOTAM type, in order to reduce the pilot's cognitive load and thus improve flight safety on the aircraft.

To that end, the present invention relates to an electronic system for assisting a civil aircraft operator in decision making, the system being intended to be carried on board the aircraft, and comprising:
an electronic display device for displaying information;
an electronic production device for producing aeronautical indicators, comprising:
   an acquisition module configured to acquire at least one aeronautical information message, each aeronautical information message comprising a header and a useful part, the useful part including several data fields, including a free-format text field called free field;
   a calculation module configured to calculate a plurality of aeronautical indicators for each acquired aeronautical information message, the aeronautical indicators being calculated via the application of an artificial intelligence algorithm to said aeronautical information message, the artificial intelligence algorithm receiving the free field as input and delivering the aeronautical indicators as output, the aeronautical indicators being distinct from the data contained in said aeronautical information message;
   a display module configured to display a readout of the calculated aeronautical indicators on the electronic display device.

With the decision-making assistance system according to the invention, the aeronautical indicators calculated and then displayed on the information display device enable the pilot to assess the impact of each aeronautical information message on the flight of the aircraft much more easily and effectively, and also to do so more precisely, since the aeronautical indicators calculated correspond to different criteria, i.e., to different types of impact.

With the decision-making assistance system according to the invention, the aeronautical indicators calculated do not result from merely filtering the content of each aeronautical information message, as they are calculated using the artificial intelligence algorithm and are distinct from the data contained in said information message.

Unlike the systems in the prior art, which essentially assess the criticality, or importance, of each NOTAM message, the decision-making assistance system according to the invention aims to assess the impact of each aeronautical information message on the flight of the aircraft, also known as the indirect impact, the aeronautical indicators advantageously being indicators for evaluating an impact of the content of the free field on the flight of the aircraft, the evaluated impact typically being an additional consumption of energy, a delay, a disruption for passengers, a disruption for the crew, including the pilot, a disruption for the external environment of the aircraft, and an ecological impact.

In other beneficial aspects of the invention, the electronic decision-making assistance system includes one or more of the following features, taken in isolation or in any technically possible combination:
each aeronautical information message is chosen from the group consisting of: a NOTAM message, a SNOWTAM message and an ASHTAM message;
the free field is chosen from the group consisting of: the E field of the NOTAM message, the T field of the SNOWTAM message and the K field of the ASHTAM message, as defined by the International Civil Aviation Organization;
the aeronautical indicators are indicators used to assess the impact of the content of the free field on the flight of the aircraft;
each aeronautical indicator preferably being chosen from the group consisting of: an indicator of additional energy consumption by the aircraft, an indicator of delay of the aircraft, an indicator of disruption for the passengers of the aircraft, an indicator of disruption for the crew of the aircraft, an indicator of disruption for an environment external to the aircraft, and an indicator of additional ecological impact;
each aeronautical indicator is expressed as a numerical value chosen from a binary value, a value from a range of at least three values, and a value from an interval of values;
the artificial intelligence algorithm is trained using training data, the calculation of aeronautical indicators being carried out during inference by the artificial intelligence algorithm, after the artificial intelligence algorithm has been trained;
the training being preferably supervised training;
the artificial intelligence algorithm preferably comprising a single model for all the aeronautical indicators or several separate models, each model being associated with one or more respective aeronautical indicators; and
the readout of the calculated aeronautical indicators includes, for each aeronautical indicator, a respective visual sign representing the value of said aeronautical indicator.

The invention also relates to a civil aircraft comprising an electronic decision-making assistance system as defined above.

The invention also relates to a decision-making assistance method for a civil aircraft operator, implemented by an electronic decision-making assistance system intended to be carried on-board the aircraft and comprising an electronic display device for displaying information and an electronic production device for producing aeronautical indicators, the method comprising the following operations:
acquiring at least one aeronautical information message, each aeronautical information message comprising a header and a useful part, the useful part including several data fields, including a free-format text field called free field;
calculating a plurality of aeronautical indicators for each acquired aeronautical information message, the aeronautical indicators being calculated via the application of an artificial intelligence algorithm to said aeronautical information message, the artificial intelligence algorithm receiving the free field as input and delivering the aeronautical indicators as output, the aeronautical indicators being distinct from the data contained in said aeronautical information message; and
displaying a readout of the calculated aeronautical indicators on the electronic display device.

The invention also relates to a non-transitory computer-readable medium including a computer program including software instructions, which, when carried out by a computer, implement a decision-making assistance method as defined above.

### BRIEF DESCRIPTION OF THE DRAWINGS

These features and advantages of the invention will appear more clearly upon reading the following description, given solely as a non-limiting example, and made in reference to the attached drawings, in which:

FIG. 1 is a schematic view of a civil aircraft according to the invention, comprising a radio transceiver and an electronic decision-making assistance system for an operator of the aircraft, the system being configured to produce and then display aeronautical indicators;

FIG. 2 is a view illustrating the display of aeronautical indicators according to two example readouts; and

FIG. 3 is a flow chart of an operator decision-making assistance method according to the invention, the method being implemented by the decision-making assistance system of FIG. 1.

### DETAILED DESCRIPTION OF THE INVENTION

In the remainder of the description, the phrase “substantially equal to” means being equal within 20%, preferably within 10%, and even more preferably within 5%.

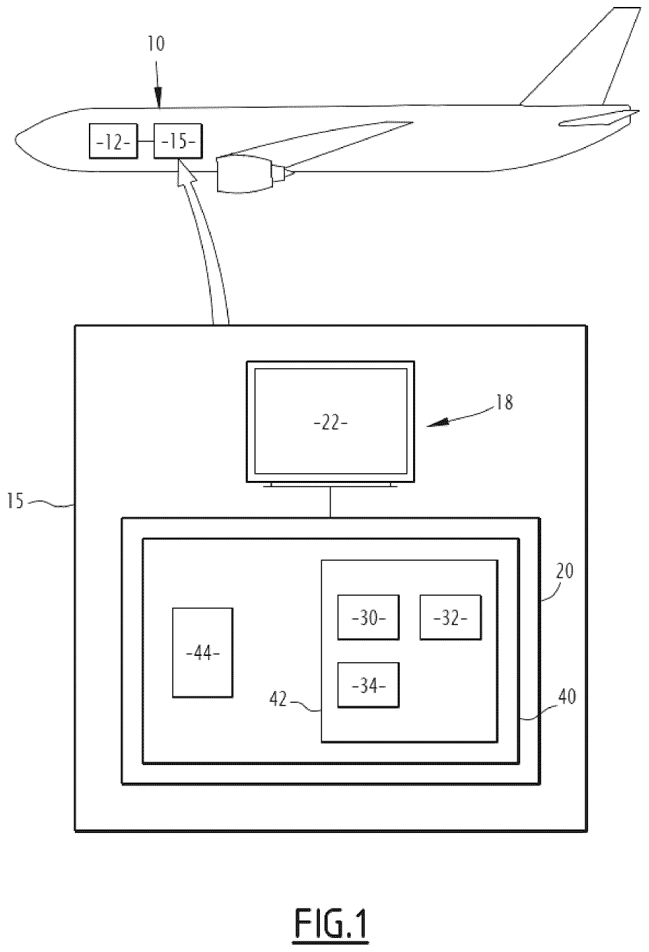

In FIG. 1, a civil aircraft 10 includes one or more radio transceivers 12 and an electronic decision-making assistance system 15, the system 15 being intended to be carried on board the aircraft 10 and to be connected to the radio transceiver(s) 12.

The civil aircraft 10 is in particular an airplane, such as an airliner, as shown in FIG. 1. Alternatively, the civil aircraft 10 is a rotary-wing aircraft, such as a civil helicopter, or a civil drone piloted remotely by a remote operator.

The operator is then typically the pilot of the civil aircraft 10.

The aircraft 10 is configured to communicate, via the radio transceiver(s) 12, with ground-based electronic systems, such as one or more aeronautical information transmission systems via a radio link, not shown.

Each aeronautical information transmission system is known per se. The aeronautical information transmission system supports, for example, an aeronautical information message M transmission service, configured to broadcast, for example, a NOTAM (NOTice to AirMen) message, a SNOWTAM message (a combination of SNOW and NOTAM), or an ASHTAM message (a combination of ASH and NOTAM), for example in the event of notification(s) of a runway, taxiway, surface with a risk or presence of snow, ice, and/or standing water (SNOWTAM message), or in the event of notification(s) concerning a change in volcanic activity which is significant for operations, a volcanic eruption and/or a volcanic ash cloud (ASHTAM message).

The transmission of NOTAM, SNOWTAM and ASHTAM messages is defined by the International Civil Aviation Organization (ICAO) and by the Federal Aviation Administration (FAA) of the United States. The transmission of NOTAM, SNOWTAM and ASHTAM messages as defined by ICAO is for example in accordance with ICAO Annex 15, Chapter 5, 16th Edition 2018; ICAO Doc 10066 “Aeronautical Information Management”, 1st Edition 2018; and/or ICAO Doc 8126 “Aeronautical Information Services Manual”, 7th Edition 2021. The transmission of NOTAM, SNOWTAM and ASHTAM messages as defined by the FAA complies, for example, with Order 7930.2R entitled “Notices to AirMen (NOTAMs)”, dated 5 Jan. 2017; and/or Circular AC 150/5200-28E entitled “Notices to AirMen (NOTAMs) for Airport Operators”, dated 30 Dec. 2016.

Each aeronautical information message M is then chosen from the group consisting of: a NOTAM message, a SNOWTAM message and an ASHTAM message.

Each radio transceiver 12 is known per se, and is adapted to transmit and/or receive radio signals, in particular to and/or from the ground-based aeronautical information transmission system(s), in particular via one or more digital data links.

The electronic decision-making assistance system 15 includes an electronic display device 18 for displaying information and an electronic production device 20 for producing aeronautical indicators, connected to the electronic display device 18.

The electronic display device 18 typically includes a screen 22 for displaying information, and a human-machine interface, not shown, for example integrated into the screen 22 in the form of a touch screen.

According to another example, the human-machine interface is a real, i.e., physical, keyboard or a virtual keyboard, or an actuatable cursor connected to the display device 18.

The human-machine interface is designed to allow the operator to select items or enter data.

The electronic production device 20 includes a module 30 for acquiring at least one aeronautical information message M, a module 32 for calculating several aeronautical indicators for each aeronautical information message M, and a module 34 for displaying a readout R1, R2 of the aeronautical indicators on the information display device 18.

In the example shown in FIG. 1, the electronic production device 20 includes an information processing unit 40 formed for example by a memory 42 and a processor 44 associated with the memory 42.

In the example of FIG. 1, the acquisition module 30, the calculation module 32 and the display module 34 are each in the form of software or a software brick, which is executed by the processor 44. The memory 42 of the electronic production device 20 is then able to store acquisition software, calculation software, and display software. The processor 44 is then able to run each of the acquisition software, calculation software, and display software.

In a variant not shown, the acquisition module 30, the calculation module 32, and the display module 34 are each in the form of a programmable logical component, such as an FPGA (Field Programmable Gate Array), or as a dedicated integrated circuit, such as an ASIC (Application-Specific Integrated Circuit).

When the electronic production device 20 is in the form of one or more software, that is to say in the form of a computer program, it is also capable of being stored on a computer-readable medium, not shown. The computer-readable medium is, for example, a medium that stores electronic instructions and be coupled with a bus from a computer system. For example, the readable medium is an optical disk, magneto-optical disk, ROM memory, RAM memory, any type of non-volatile memory (for example EPROM, EEPROM, FLASH, NVRAM), magnetic card or optical card. The readable medium in such a case stores a computer program comprising software instructions.

The acquisition module 30 is configured to acquire at least one aeronautical information message M, each aeronautical information message M including a header and a useful part, the useful part including several data fields, including a free-format text field called free field.

In the example of the NOTAM message, according to the ICAO definition, in particular according to chapter 6 of part III of the aforementioned Doc 8126 document, the NOTAM format consists of two parts, namely a part a) forming the heading and a part b) forming the useful section, containing the NOTAM information. Part a) forming the heading contains a priority indicator, addresses, date and time of filing and an indicator of the originator of the message, as subsequently specified in Chapter 9 of Part III of the aforementioned Doc 8126. Part b) forming the useful section includes several data fields, including fields successively denoted Q, then A to G, and the free field corresponds to field E. According to the aforementioned document Doc 8126, field E provides information about a NOTAM in plain language, i.e., uniform abbreviated phraseology and, where necessary, ICAO abbreviations, indicators, identifiers, designators, call signs, frequencies, digits and plain language. The NOTAM format is also specified in Annex 3 of the above-mentioned Doc 10066.

In the example of the SNOWTAM message, according to the ICAO definition, in particular according to Chapter 7 of Part III of the aforementioned Doc 8126, the SNOWTAM format includes three parts, namely part a) forming a heading, part b) intended for automatic processing in computer data banks, forming an abbreviated heading, and part c) forming the useful section and containing the SNOWTAM information. Part a) forming the heading contains a priority indicator, addresses, date and time of filing and an indicator of the originator of the message, as subsequently specified in Chapter 9 of Part III of the aforementioned Doc 8126. Part b) forming the abbreviated heading contains a SNOWTAM serial number, as well as the location, date and time of observation. Part c) forming the useful section includes several data fields, including fields successively labelled A to T, and the free field corresponds to field T. The SNOWTAM format is also specified in Appendix 4 of the aforementioned document Doc 10066. According to this Appendix 4, field T describes in plain language any information of operational importance, while always indicating a length of uncleaned runway (point D) and an extent of runway contamination (point F) for each third of the runway and according to a scale specified in this Appendix 4.

In the example of the ASHTAM message, according to the ICAO definition, in particular according to Chapter 8 of Part III of the aforementioned Doc 8126, the ASHTAM format consists of three parts, namely part a) forming a heading, part b) intended for automatic processing in computer data banks, forming an abbreviated heading, and part c) forming the useful section and containing the SNOWTAM information. Part a) forming the heading contains a priority indicator, addresses, date and time of filing and an indicator of the originator of the message, as subsequently specified in Chapter 9 of Part III of the aforementioned Doc 8126. Part b) forming the abbreviated heading contains an ASHTAM serial number, as well as the location, date and time of observation. Part c) forming the useful section includes several data fields, including fields successively labelled A to K, and the free field corresponds to field K. The ASHTAM format is also specified in Appendix 5 of the aforementioned document Doc 10066. According to the aforementioned document Doc 8126 or according to this Appendix 5 of document Doc 10066, field K includes all operationally significant information in addition to the above in fields A to J, in plain and simple language.

According to the FAA definition, the format of the aeronautical information message M is similar to the ICAO format, as defined above, but by structuring the information in a particular order instead of using letters to identify the fields, i.e., the categories of information.

According to the FAA definition, there is no specific free field for the NOTAM message, the SNOWTAM message or the ASHTAM message, and the free field is part of said message.

The calculation module 32 is configured to calculate several aeronautical indicators for each aeronautical information message M acquired, via the application of an artificial intelligence algorithm to said aeronautical information message M. The aeronautical indicators are distinct from the data contained in said aeronautical information message M.

For each aeronautical information message M, the artificial intelligence algorithm receives the free field as input and delivers the aeronautical indicators as output.

The artificial intelligence algorithm has been trained using training data during a prior training operation. Aeronautical indicators are calculated when the artificial intelligence algorithm makes an inference after said training. Advantageously, the training is supervised training.

During training, the training data typically comprises, as input data, free fields of multiple aeronautical information messages M, and as output data, expected values, i.e., target values, for each aeronautical indicator, for each corresponding free field in the input.

For example, the artificial intelligence algorithm includes, for example, a single model for all aeronautical indicators.

Alternatively, the artificial intelligence algorithm includes several distinct models, each model being associated with one or more respective aeronautical indicators.

The training method is identical no matter how many models are included in the artificial intelligence algorithm.

Alternatively, if the artificial intelligence algorithm includes several distinct models, training is carried out for each respective model, with training data specific to each model. In other words, training is then differentiated from one model to another, using different training data from one model to another.

Advantageously, the aeronautical indicators are indicators used to assess the impact of the content of the free field on the flight of the aircraft 10.

According to this advantageous aspect, each aeronautical indicator is, for example, an indicator of additional energy consumption by the aircraft 10, or an indicator of delay of the aircraft 10, or an indicator of disruption for the passengers of the aircraft 10, or an indicator of disruption for the crew of the aircraft 10, or an indicator of disruption for an environment external to the aircraft 10, or an indicator of additional ecological impact.

Table 1 contains examples of the information contained in the free field of the aeronautical information message M for each respective indicator.

TABLE 1

| Indicators | Examples of information in the free field |
|---|---|
| Additional | Longer routes, different altitudes, go-arounds, |
| energy | waiting turns, airport closures . . . |
| consumption | |
| Delay | Runway closure, weather conditions, strike, longer |
| | routes, go-around, ground hold, equipment |
| | malfunctions, airspace restriction . . . |
| Disruption to | Weather conditions, strike, turbulence, go-around, |
| passengers | ground hold, delay . . . |
| Disruption to | Low altitude, Noise abatement, rerouting . . . |
| the external | |
| environment | |
| Disruption to | High coordination/communication, rerouting, |
| the crew | extended flight times . . . |
| Additional | Rerouting, airport closure, noise pollution . . . |
| ecological | |
| impact | |

When the aeronautical indicator is the additional energy consumption indicator, it provides the operator with an indication of the additional energy consumption generated by the content of the free field of the corresponding aeronautical information message M. Similarly, when the aeronautical indicator is the delay indicator, it provides the operator with an indication of the delay past the initially scheduled arrival time, caused by the content of the free field of the corresponding aeronautical information message M. Similarly, when the aeronautical indicator is a respective disruption indicator from among the disruption for passengers, the disruption for the crew and the disruption for the external environment, the corresponding indicator provides an indication to the operator as to a possible respective disruption, and advantageously as to a respective level of disruption, caused by the content of the free field of the corresponding aeronautical information message M. Similarly, when the aeronautical indicator is the additional ecological impact indicator, it provides an indication to the operator of an additional ecological impact caused by the content of the free field of the corresponding aeronautical information message M. The ecological impact is, for example, emission of an additional quantity of carbon dioxide resulting from additional fuel consumption.

Each aeronautical indicator is expressed, for example, in the form of a binary value, or a value from a range of at least three values, or a value from an interval of values.

The skilled person will understand that when the aeronautical indicator is expressed in the form of a binary value, i.e., a Boolean, it simply provides an indication as to the presence or absence of an impact, such as additional energy consumption, delay, disruption or additional ecological impact. Advantageously, when the aeronautical indicator is expressed as a range of at least three values, or as a value in an interval of values, it also provides an indication of the level of impact when such impact is present.

The display module 34 is configured to display, on the information display device 18, the readout R1, R2 of the aeronautical indicators calculated by the calculation module 32.

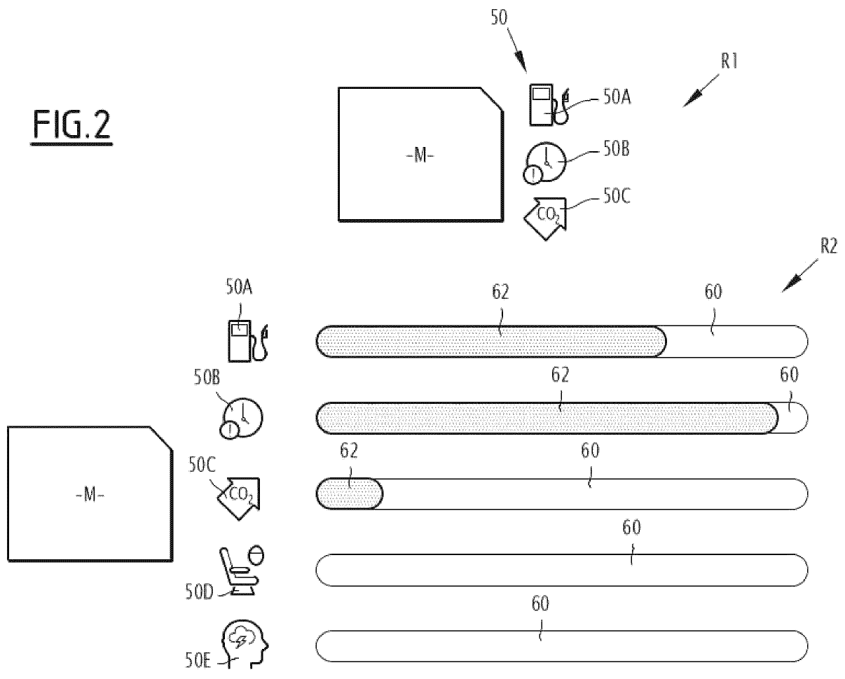

Advantageously, the readout R1, R2 of the calculated aeronautical indicators includes, for each aeronautical indicator, a respective visual sign 50, also called symbol, representing the value of said aeronautical indicator, as shown in FIG. 2.

Alternatively, the readout of the calculated aeronautical indicators includes, for each aeronautical indicator, a string of alphanumeric characters, i.e., a text message, typically corresponding to the name of the indicator, such as “additional energy consumption” or “delay”, explaining the aeronautical indicator in question. Advantageously, according to this variant, this text readout further includes an indication of the value or level of the calculated indicator, such as “slight delay”, “moderate delay” or “long delay”.

In the example shown in FIG. 2, a first visual sign 50A, or first symbol 50A, corresponds to the additional energy consumption indicator; a second visual sign 50B, or second symbol 50B, corresponds to the delay indicator; a third visual sign 50C, or third symbol 50C, corresponds to the additional ecological impact indicator; a fourth visual sign 50C, or fourth symbol 50C, corresponds to the disruption to passengers indicator; and a fifth visual sign 50E, or fifth symbol 50E, corresponds to the disruption to crew indicator; a visual sign corresponding to the disruption to the external environment indicator not being shown in FIG. 2.

This example in FIG. 2 illustrates a first readout R1, according to which the aeronautical indicators calculated are expressed in the form of binary values, i.e., Booleans, and the presence of the impact is then displayed via the display of the respective visual sign 50 corresponding to the indicator concerned, the absence of the impact corresponding to an absence of displaying the visual sign 50 corresponding to the indicator in question. In the example shown in FIG. 2, only the first 50A, second 50B and third 50C symbols are displayed for the first readout R1, which means that the aeronautical information message M in question has an impact in terms of additional energy consumption, delay and additional ecological impact, and no impact in terms of disruption for passengers and crew. Alternatively, the absence of impact is displayed in the form of a specific symbol, distinct from the respective symbols 50 associated with the calculated indicators.

This example in FIG. 2 also illustrates a second readout R2, in which the calculated aeronautical indicators are expressed as a value from a range of values. For this second readout R2, the range of values is then represented in the form of a scale 60, and the value of the corresponding indicator is represented in the form of a cursor along this scale 60, or a level 62 within this scale. In the example shown in FIG. 2, the person skilled in the art will observe that the cursor is at the minimum of the scale 60, the level 62 not exceeding the minimum, for the fourth 50D and fifth 50E symbols, which corresponds to an absence of impact in terms of disruption to passengers, to the crew, in a similar way to the first readout R1. The second readout R2 also makes it possible to inform the operator that the aeronautical information message M in question has a fairly high impact in terms of additional energy consumption, a high impact in terms of delay and a low impact in terms of additional ecological impact, the level 62 being close to the maximum value for the second symbol 50B corresponding to the delay indicator, substantially equal to three-quarters of the maximum value for the first symbol 50A corresponding to the additional energy consumption indicator, and close to the minimum value for the third symbol 50C corresponding to the additional ecological impact indicator.

The skilled person will then understand that the second readout R2 provides the operator with more decision-making assistance than the first readout R1, by informing him not only of the presence or absence of the impact corresponding to the calculated indicator, but also of the level of the impact when it is present for the calculated indicator.

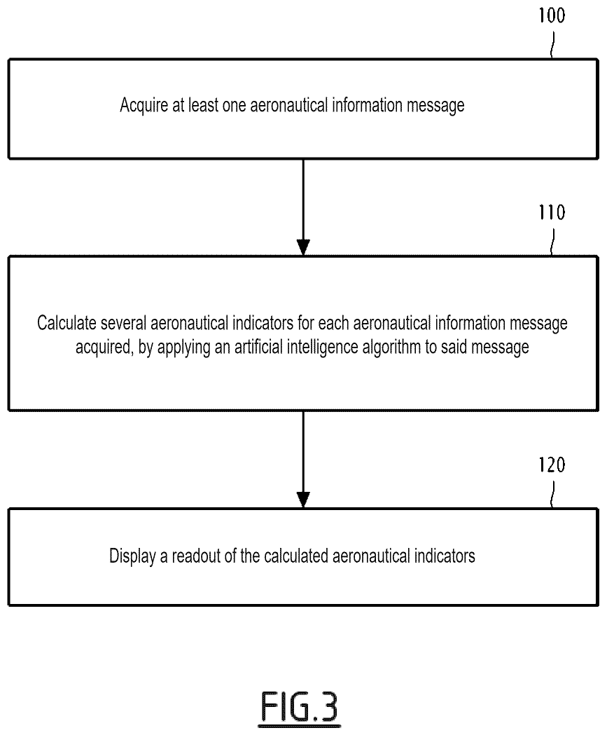

The operation of the electronic decision-making assistance system 15, and in particular of the electronic production device 20, will now be explained, in particular using FIG. 3, which shows a flowchart of the method, according to the invention, for assisting the decision-making of the operator of the aircraft 10.

During an initial operation 100, the electronic production device 20 acquires, via its acquisition module 30, one or more aeronautical information messages M, such as one or more NOTAM, SNOWTAM and/or ASHTAM messages.

The electronic production device 20 then calculates, in the next operation 110 and via its calculation module 32, several aeronautical indicators for each aeronautical information message M acquired during the acquisition state 100.

During the calculation operation 110, the aeronautical indicators are calculated by applying the artificial intelligence algorithm to each aeronautical information message M acquired. During this inference by the artificial intelligence algorithm, the artificial intelligence algorithm receives as input the free field of each aeronautical information message M acquired, and delivers as output the aeronautical indicators calculated for each aeronautical information message M.

The aeronautical indicators are distinct from the data contained in the aeronautical information message M, and this calculation operation 110 is then distinct from merely filtering the content of each aeronautical information message M acquired.

Finally, in a subsequent operation 120, the electronic production device 20 displays, via its display module 34, the readout R1, R2 of the aeronautical indicators calculated during the calculation operation 110.

During this display operation 120, the readout is, for example, in the form of the first readout R1, or the second readout R2, each of which is illustrated in FIG. 2.

In this way, the aeronautical indicators calculated and then displayed on the display device 18 enable the pilot to assess the impact of each aeronautical information message M on the flight of the aircraft 10 much more easily and effectively. In addition, this assessment is more precise, as the aeronautical indicators calculated correspond to different types of potential impact, such as impacts in terms of additional energy consumption, delays, additional ecological impact, disruption to passengers and crew, and the external environment.

Unlike systems in the prior art which essentially assess the criticality, or importance, of each NOTAM message, the decision-making assistance system 15 according to the invention makes it possible to estimate the indirect impact of each aeronautical information message M on the flight of the aircraft 10.

It is thus conceivable that the electronic system 15 and the decision-making assistance method according to the invention could provide significant assistance to the pilot of the aircraft in taking into account the aeronautical information messages M, and in so doing reduce the cognitive load on the pilot and thus to improve the safety of the flight of the aircraft 10.

1. An electronic decision-making assistance system for assisting the decision-making of an operator of a civil aircraft, the system being carried on-board the aircraft, the system comprising:
an electronic display displaying information; and
an electronic producer producing aeronautical indicators, comprising:
an acquirer acquiring at least one aeronautical information message, each aeronautical information message comprising a heading and a useful section, the useful section including several data fields, including a free-format text field, designated free field, each aeronautical information message being chosen from the group consisting of: a NOTAM message, a SNOWTAM message and an ASHTAM message, and the free field being chosen from the group consisting of: field E of the NOTAM message, field T of the SNOWTAM message, and field K of the ASHTAM message, as defined by the International Civil Aviation Organization;
a calculator calculating a plurality of aeronautical indicators for each acquired aeronautical information message, the aeronautical indicators being calculated via application of an artificial intelligence (AI) algorithm to the aeronautical information message, the AI algorithm receiving the free field as input and delivering the aeronautical indicators as output, the aeronautical indicators being distinct from the data contained in the aeronautical information message; and
a display displaying a readout of the calculated aeronautical indicators on the electronic display.

2. The system according to claim 1, wherein the aeronautical indicators comprise indicators for evaluating an impact of the content of the free field on the flight of the aircraft.

3. The system according to claim 2, wherein each aeronautical indicator is chosen from the group consisting of: an indicator of additional energy consumption by the aircraft, an indicator of delay of the aircraft, an indicator of disruption for the passengers of the aircraft, an indicator of disruption for the crew of the aircraft, an indicator of disruption for an environment external to the aircraft, and an indicator of additional ecological impact.

4. The system according to claim 1, wherein each aeronautical indicator is expressed as a numerical value chosen from a binary value, a value from a range of at least three values, and a value from an interval of values.

5. The system according to claim 1, wherein the AI algorithm is trained using training data, the calculation of aeronautical indicators being carried out during inference by the AI algorithm, after the AI algorithm has been trained.

6. The system according to claim 5, wherein the training is a supervised training.

7. The system according to claim 5, wherein the AI algorithm comprises a single model for all the aeronautical indicators.

8. The system according to claim 5, wherein the AI algorithm comprises several separate models, each model being associated with one or more respective aeronautical indicators.

9. The system according to claim 1, wherein the readout of the calculated aeronautical indicators comprises, for each aeronautical indicator, a respective visual sign representative of the value of the aeronautical indicator.

10. A civil aircraft comprising an electronic system for assisting the decision-making of an operator according to claim 1.

11. A decision-making assistance method for an operator of a civil aircraft, implemented by an electronic decision-making assistance system carried on-board the aircraft and comprising an electronic display displaying information and an electronic producer producing aeronautical indicators, the method comprising:
acquiring, by the electronic producer, at least one aeronautical information message, each aeronautical information message comprising a heading and a useful section, the useful section including several data fields, including a free-format text field, designated free field, each aeronautical information message being chosen from the group consisting of: a NOTAM message, a SNOWTAM message and an ASHTAM message, and the free field being chosen from the group consisting of: field E of the NOTAM message, field T of the SNOWTAM message, and field K of the ASHTAM message, as defined by the International Civil Aviation Organization;
calculating, by the electronic producer, a plurality of aeronautical indicators for each acquired aeronautical information message, the aeronautical indicators being calculated via the application of an artificial intelligence (AI) algorithm to said aeronautical information message, the AI algorithm receiving the free field as input and delivering the aeronautical indicators as output, the aeronautical indicators being distinct from the data contained in the aeronautical information message; and
displaying, by the electronic producer, a readout of the calculated aeronautical indicators on the electronic display.

12. A non-transitory computer-readable medium including a computer program comprising software instructions which, when executed by a computer, implement a method according to claim 11.
